(19) United States
(12) Patent Application Publication
(10) Pub. No.: US 2016/0179779 A1
(43) Pub. Date: Jun. 23, 2016

(54) CULTIVATION ASSISTANCE DEVICE, CULTIVATION ASSISTANCE METHOD, AND RECORDING MEDIUM FOR STORING PROGRAM

(71) Applicant: NEC Solution Innovators, Ltd., Koto-ku, Tokyo (JP)

(72) Inventor: Hideo SHIMAZU, Tokyo (JP)

(21) Appl. No.: 14/910,484

(22) PCT Filed: Jul. 22, 2014
(86) PCT No.: PCT/JP2014/003850

§ 371 Date: Feb. 5, 2016

(30) Foreign Application Priority Data
Sep. 4, 2013 (JP) 2013-182958

(51) Int. Cl. G06F 17/24; A01G 1/00

(52) U.S. Cl. CPC G06F 17/245; A01G 1/001

(57) ABSTRACT

In the cultivation of farm products, it is difficult to achieve target values for sugar content, etc. at the time of shipment. The cultivation assistance device is provided with: a growth data-setting means for selecting or generating a growth table comprising intermediate target values, which are determined from cultivation conditions including cultivation region, species, and shipment time as well as final target values, for multiple intermediate time points until shipment time and storing the table in a growth data-storing means; a growth data-storing means; a guidance content-storing means for storing guidance content corresponding to differences between the values measured for a crop, the cultivation of which is being assisted, and the intermediate target values; and a guidance content-selecting means for acquiring the values measured for the crop, the cultivation of which is being assisted, at each of multiple intermediate time points, comparing with the intermediate target values for said intermediate time points, and on the basis of the differences between the two, selecting and outputting guidance content from the guidance content-storing means.

### TECHNICAL FIELD

The present invention relates to a cultivation assistance device, a cultivation assistance method, and a recording medium storing a program, for farm products and the like.

### BACKGROUND ART

The cultivation of farm products in an open field requires various types of care such as irrigation, fruit thinning, flower thinning, and pest control in the process of growing. Different methods of care are adopted in accordance with the phases of growth and degrees of growth of the farm products.

An “early-ripening Satsuma mandarin (Wase-Unshiu)” that is a member of the citrus family, for example, blooms in June, and ripens and is harvested in December. Wase-Unshiu is sold at a high price when it has a certain fruit size, is sweet, and preserves its moderate acidity. A farmer cuts off water supply to the trees to an extent that does not weaken them to increase the sugar content (restricted water supply) in July and August, and supplies a relatively large amount of water to the trees to increase the fruit size and lower the acidity (irrigation) in and after September. However, if the sugar content is sufficiently high even in July and August, restricted water supply that may impair the tree health is unnecessary; or if the sugar content is insufficient even after September, restricted water supply is required to an extent that does not weaken the trees. In this manner, a variety of measures are taken at subtly different timings and levels, depending on the weather of the year.

A practical farmer has tacit knowledge of how to adjust these timings and levels in his or her head. Converting the tacit knowledge of the practical farmer into explicit knowledge enables stable cultivation of farm products with high quality.

In this respect, the following related art technologies are available.

With a method according to PTL 1, an operation evaluation time is calculated from the operation history of farming operations and an instruction for an evaluation operation that has entered the evaluation time is output.

A device according to PTL 2 receives information representing the states of fruit trees or fruits and stores the received information as history data in association with the identifier and the input date and time of each fruit tree or fruit. The device generates fruit cultivation process information from the history data, based on a predetermined determination criterion.

A device according to PTL 3 stores operation rule information including information representing the states of crops, conditions associated with the states of crops, and operation information representing operations to be performed when the conditions are satisfied. The device extracts operation rule information including conditions that match information representing the input state of a crop, and outputs operation information included in the extracted operation rule information.

A device according to PTL 4 calculates a predicted sugar content based on a dry matter ratio and a starch content obtained by a measuring device after cultivated fruit bearing. When the predicted sugar content is lower than a given target sugar content during a predetermined period after fruit bearing, the device outputs the fertilizer concentration, the amount of nutrient solution supplied, or the nutrient solution supply count to a nutrient solution supply controller. When the predetermined period elapses after fruit bearing, the device sets cultivation conditions by PID (Proportional Integral Derivative) control based on the value of the predicted sugar content, a change in this value, and the target sugar content. The device outputs the fertilizer concentration, the amount of nutrient solution supplied, or a value indicating the number of changes in nutrient solution supply count to the nutrient solution supply controller, in accordance with the difference between the predicted sugar content and the target sugar content.

### CITATION LIST

### Patent Literature

[PTL 1] International Publication WO 2012/120689

[PTL 2] Japanese Unexamined Patent Application Publication No. 2012-181633

[PTL 3] Japanese Unexamined Patent Application Publication No. 2012-039964

[PTL 4] Japanese Unexamined Patent Application Publication No. 2008-054573

### SUMMARY OF INVENTION

### Technical Problem

It is hard for all of the related art technologies to achieve a target value for the sugar content or the like at the time of shipment in the cultivation of farm products.

It is difficult to set an appropriate determination criterion in the device according to PTL 2. It is difficult to set appropriate conditions in the device according to PTL 3. The device according to PTL 4 is incapable of appropriate processes because a process is determined based on the value of the predicted sugar content, a change in this value, and the fixed target sugar content.

It is an object of the present invention to provide a technique for solving the above-mentioned difficulty.

### Solution to Problem

A cultivation assistance device includes: growth data setting means for selecting or generating a growth table including intermediate target values for a plurality of intermediate time points until the shipment time, and storing the growth table in growth data storage means, the intermediate target values being determined from cultivation condition including a cultivation region, a species, a shipment time, and a final target value; the growth data storage means; guidance content storage means for storing a guidance content depending on differences between the intermediate target values and measured value for a crop to be cultivated with assistance; and guidance content selection means for acquiring the measured value for the crop to be cultivated with assistance at an intermediate time point in the plurality of intermediate time points, for each of the plurality of intermediate time points, comparing the measured value with an intermediate target value at the intermediate time point in the intermediate target values, and selecting and outputting the guidance content from the guidance content storage means, based on differences between the measured value and the intermediate target value.

A cultivation assistance method includes: selecting or generating a growth table including intermediate target values for a plurality of intermediate time points until the shipment time, and storing the growth table in growth data storage means, the intermidiate target values being determined from cultivation condition including a cultivation region, a species, a shipment time, and a final target value; storing, in guidance content storage means, a guidance content depending on differences between the intermediate target values and measured values for a crop to be cultivated with assistance; and acquiring the measured value for the crop to be cultivated with assistance at an intermediate time point in the plurality of intermediate time points, for each of the plurality of intermediate time points, comparing the measured value with an intermediate target value at the intermediate time point in the intermediate target values, and selecting and outputting the guidance content from the guidance content storage means, based on differences between the measured values and the intermediate target value.

A recording medium storing a program causing a computer to execute: processing of selecting or generating a growth table including intermediate target values for a plurality of intermediate time points until the shipment time, and storing the growth table in growth data storage means, the intermidiate target values being determined from cultivation condition including a cultivation region, a species, a shipment time, and a final target value; processing of storing, in guidance content storage means, a guidance content depending on differences between the intermediate target values and measured values for a crop to be cultivated with assistance; and processing of acquiring the measured value for the crop to be cultivated with assistance at an intermediate time point in the plurality of intermediate time points, for each of the plurality of intermediate time points, comparing the measured values with an intermediate target value at the intermediate time point in the intermediate target values, and selecting and outputting the guidance content from the guidance content storage means, based on differences between the measured value and the intermediate target value.

### Advantageous Effects of Invention

The present invention makes it easy to achieve a target value such as a target sugar content at the time of shipment in the cultivation of farm products.

### BRIEF DESCRIPTION OF DRAWINGS

FIG. 1 is a block diagram illustrating a configuration of a cultivation assistance device 9 according to a first exemplary embodiment.

FIG. 2 illustrates a structure of data used by the cultivation assistance device 9 according to the first exemplary embodiment, and its storage units.

FIG. 3 illustrates a structure of other data used by the cultivation assistance device 9 according to the first exemplary embodiment, and its storage unit.

FIG. 4 is a block diagram illustrating a configuration of a cultivation assistance device 9 according to a third exemplary embodiment.

FIG. 5 illustrates a structure of data used by the cultivation assistance device 9 according to the third exemplary embodiment, and its storage units.

FIG. 6 illustrates a structure of data used by a cultivation assistance device 9 according to a fourth exemplary embodiment, and its storage units.

FIG. 7 illustrates exemplary growth prediction data.

FIG. 8 is a figure for explaining an operation of the cultivation assistance device 9.

FIG. 9 is a figure for explaining the standard deviation.

FIG. 10 is another figure for explaining the standard deviation.

FIG. 11 is a block diagram illustrating a configuration of a cultivation assistance device 9 according to a fifth exemplary embodiment.

### DESCRIPTION OF EMBODIMENTS

A device and the like according to the present invention use a strategic model for cultivation by a practical farmer. Although citrus fruits will be taken as an example herein, the present invention is not limited to citrus fruits and is intended for the general farm products.

Examples of attributes to determine the quality of a citrus fruit at the time of shipment may include its sugar content, acidity, size, and color. An attribute value for each piece of fruit is measured in a fruit assorting house at the time of shipment. Scores are assigned to the attribute values. Pieces of fruit are graded in accordance with a combination of scores, packed in boxes for each grade, and shipped.

L-sized pieces of fruit, for example, are classified into a special-grade L size, a good-grade L size, and a medium-grade L size. Only pieces of fruit whose attribute values for the sugar content, acidity, and color fall within specific ranges are selected as special-grade products. The purchase price of each piece of fruit depends on whether this piece of fruit is classified into a special-grade L size, a good-grade L size, or a medium-grade L size, and the sum of purchase prices is the total sales revenue (purchase price) at the time of shipment for a specific farmer.

As described above, since the shipment price of a piece of fruit is precisely determined based on the score, an active practical farmer plans cultivation strategies so as to maximize his or her shipment value. A farmer who prefers quality to quantity, for example, spends much time in caring each individual tree. On the other hand, a farmer who owns a piece of farm land through which underground flow extends and which is always drained too poorly to increase the sugar content and, in turn, to nurture special-grade fruits, may employ a strategy that attaches greater importance to quantity than quality. A part-time farmer who spends less time in going out to his or her piece of farm land and performing care often prefers quantity to quality as well.

A practical farmer plans the following three strategies in cultivation.

In the first strategy, the practical farmer defines an “ideal situation” at the time of shipping his or her farm products. Examples of this definition may include “the sugar content is 14 degrees Brix” and “the size is an LL size.” The practical farmer then takes a measure to bring growing fruits close to the “ideal situation.”

In the second strategy, the practical farmer holds an image of growth prediction of farm products in his or her mind and performs care in cultivation in accordance with the image. For example, the practical farmer pictures a time-series growth change in his or her mind based on the past instances. Examples of this change may include “a species having a sugar content of 13 degrees Brix in December has a sugar content of 12 degrees Brix in November, 11 degrees Brix in October, 10 degrees Brix in September, . . . ” The practical farmer experimentally knows that a sugar content of 13 degrees Brix can hardly be reached in December if the sugar content has not reached 11 degrees Brix in October. Thus, the practical farmer compares the current conditions with the past experiences every month to determine whether the fruit is growing steadily, and takes a measure to correct too rapid growth or too slow growth if the fruit is growing too rapidly or too slowly.

In the third strategy, the practical farmer compares the rate of maturation in his or her own field with those of other farmers in the same production district. The practical farmer determines whether the rate of maturation in his or her own field is more rapid or slower than or equal to an average and changes the level of growth promotion. Since the weather varies each year, farm products in the present year do not necessarily grow in the same state as in the last year even when the practical farmer cultivates them in the same field. Thus, the practical farmer compares the state of his or her own field with farm products cultivated by an adjacent farmer in the same production district, to evaluate the state of his or her own field free from the influence of the weather. The same production district shows similar weathers. If the present year's weather is colder than usual, farm products are more likely to be growing at a relatively low rate not only in the field of the practical farmer but also in other fields of the same production district. Conversely, if the present year's weather is warmer than usual, farm products are expected to be growing at a relatively high rate in all fields of the same production district. A certain practical farmer owns a piece of farm land that is filled with sunlight and yearly bears crops better than an average in the production district. This practical farmer may expect crops better than an average in the production district in the present year as usual, irrespective of the weather.

The device and the like according to the present invention incorporate the strategic model of the practical farmer and define an “ideal situation” in advance. In response to input of “the current state of a crop” in the process of cultivation, this device and the like generate and output a measure to be taken at that time.

In such cultivation, the following premises generally hold true.

As the first premise, a plurality of farmers share information with each other among them while independently managing their farms in each production district. In general, farmers in the same production district cooperate with among them while competing with among them. This is because such farmers ship farm products named after the same production district. Such farmers exchange information concerning the states of a crop in their own fields with among them on a week-by-week or month-by-month basis. Alternatively, an agricultural cooperative for coordination enables such farmers to refer to the states of a crop anonymously among them. This information sharing takes place, assuming that respective farmers measure various attributes (for example, the sugar content, acidity, and size) of a crop in the process of cultivation and are allowed to refer to the values of these attributes among them.

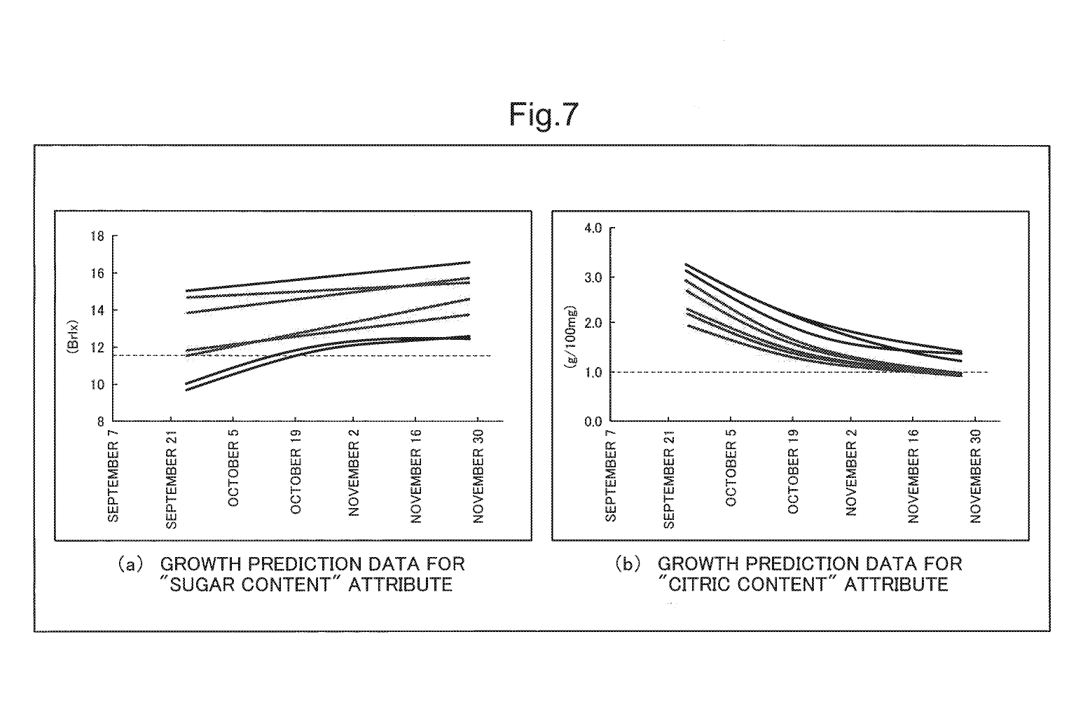

As the second premise, time-series data of predicted values for the attribute values are recorded as a growth prediction graph in advance for each species in the production district. FIG. 7 illustrates graphs of time-series data of the sugar content and the citric content (acidity) actually measured in the production district. This data represents a past instance. However, since the same tendency as in this data is considered to continue until the present year as long as the same species in the same production district is targeted, this data can be used as growth prediction data. It is often the case that data as illustrated in FIG. 7 has already been recorded by prefectural agriculture promotion facilities or agricultural cooperatives in respective production districts. However, no growth prediction graph is uniquely determined from the species and the production district. For the same species and production district, a plurality of growth prediction graphs exist, including a growth prediction graph for a fruit having a sugar content of 14 degrees Brix at the time of shipment, a growth prediction graph for a fruit having a sugar content of 12 degrees Brix at the time of shipment, and a growth prediction graph for a fruit having a sugar content of 10 degrees Brix at the time of shipment. Each of the two graphs illustrated in FIG. 7 includes a plurality of polygonal lines. The respective polygonal lines can be regarded as different growth prediction graphs.

As the third premise, a measure to correct a discrepancy of an attribute value at each time from the growth prediction graph when this occurs is recorded in advance by a cultivation expert. The measure may be, for example, presented as follows: “Perform restricted water supply (the restriction of irrigation) when the current sugar content is 10 degrees Brix, although the sugar content is expected to be 11 degrees Brix in October in terms of the growth prediction graph.” To the contrary, the measure may be presented as follows: “Focus attention on lowering the size and acidity by irrigation with more water when the current sugar content is 12 degrees Brix.”

Under these three premises, each farmer represents and records the crop species and ideal values (to be referred to as goal values hereinafter) for its attributes when he or she ships the crop, at the start of cultivation. Examples of the goal values may include “shipment with a sugar content of 13 degrees Brix” and “shipment with an LL size (12 centimeters or more). Each farmer periodically (for example, on a month-by-month or week-by-week basis) measures and records the attribute values of the crop species in the process of cultivation.

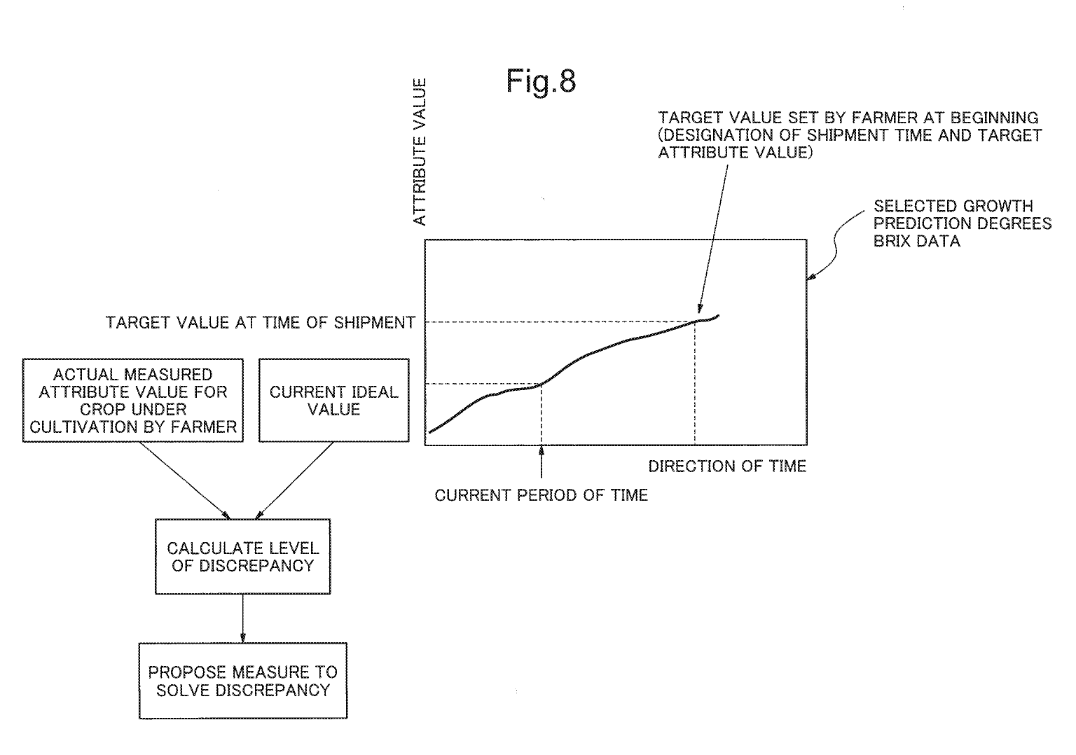

The device and the like according to the present invention refer to, based on a species and a goal value set by the farmer, a growth prediction graph for achieving the goal value, and check an attribute value required at a specific time to achieve the goal value. The device and the like compare the attribute value during the current period of time with the value of the growth prediction graph, and select and present a measure to solve a discrepancy between these values to the farmer when the discrepancy occurs (see FIG. 8).

When the attribute value of the growth prediction graph and the current attribute value have too large a discrepancy to be compensated for, it is difficult to predict the growth in accordance with this growth prediction graph. In this case, it is practical to predict the growth based on a growth prediction graph which takes a value close to the current attribute value. This procedure is similar to the selection of the school of one's choice in preparation for a college entrance examination. Assume, for example, that a student preparing for an entrance examination selects the University of Tokyo as the school of his or her initial choice and studies. If the student gets a low probability of acceptance to the University of Tokyo in every mock examination, he or she may give up on going to the University of Tokyo and change the school of his or her choice to a university having a deviation value as low as his or her own academic ability, to make certain that he or she will gain acceptance. The situation of the practical farmer is similar to this situation. The device and the like according to the present invention further incorporate a function of advising a change in goal value when the current attribute value and the value of the growth prediction graph have a large discrepancy.

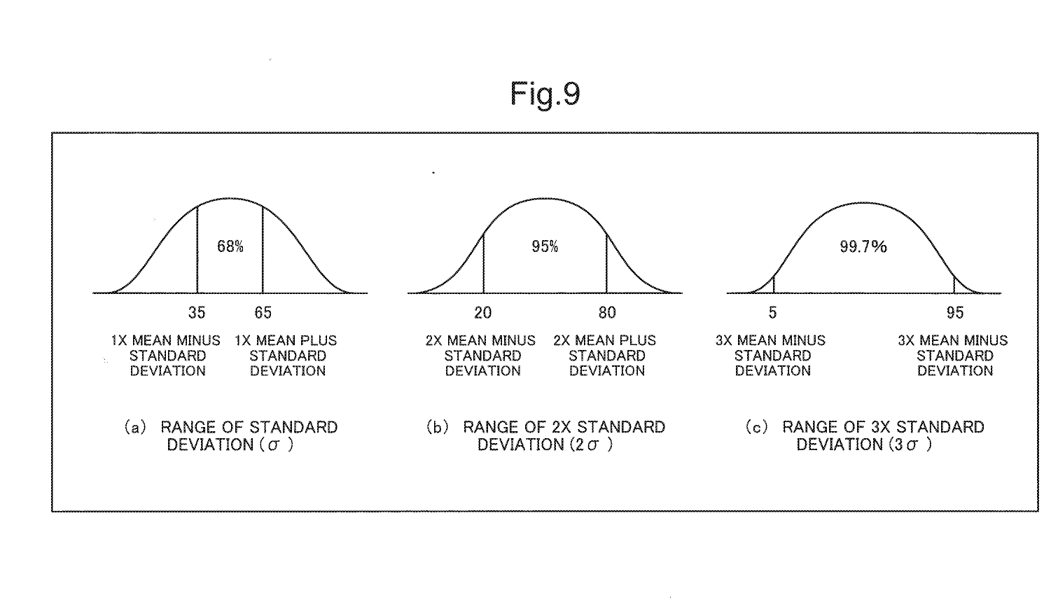

When each individual farmer in the same production district periodically declares attribute values, the average and standard deviation of the production district can be calculated from these attribute values. When the attribute values of a crop produced by a specific farmer are greatly discrepant from the average and standard deviation of the production district, the device and the like according to the present invention present a measure to solve the discrepancy to the farmer. This measure is registered in the device and the like in advance. As shown in FIG. 9, if the farmer falls within σ (standard deviation) in the production district, he or she can find himself or herself at the average position of the production district. If the farmer falls outside 2σ, he or she can find himself or herself under very special circumstances.

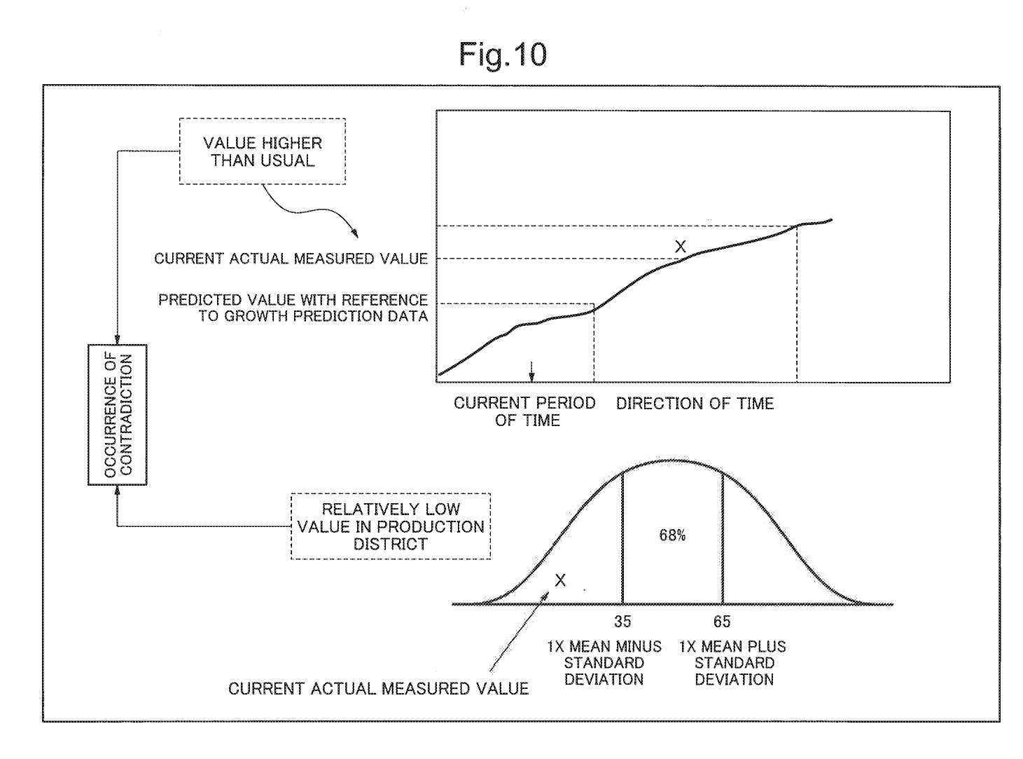

When a measure to solve a discrepancy from the growth prediction graph and a measure to solve a discrepancy from the average and standard deviation of the production district are independently presented, totally opposite measures are more likely to be presented. As illustrated in FIG. 10, when, for example, the present year's weather is hotter than usual and the sugar content is higher than the value of the growth prediction graph based on the value in an average year, the measure may be presented as follows: “It is better to perform a little irrigation”. However, if the present year's amount of precipitation is larger than usual in the production district, crops produced by all farmers may have a sugar content higher than usual. When the sugar content of a crop produced by the farmer of interest is relatively low in the production district, the measure may be presented as follows: “Increase the sugar content by more severely restricted water supply”. In this case, the two measures are totally opposite to each other.

When inconsistent measures are generated, the device and the like according to the present invention do not determine which one is to be adopted. A farmer who uses the device and the like determines which measure is to be adopted. When the two measures are totally opposite to each other, the farmer may think that “the circumstances involved may cause different types of decisions and I should produce a proper idea in that case.” Then, the farmer will naturally make a deliberate decision.

### First Exemplary Embodiment

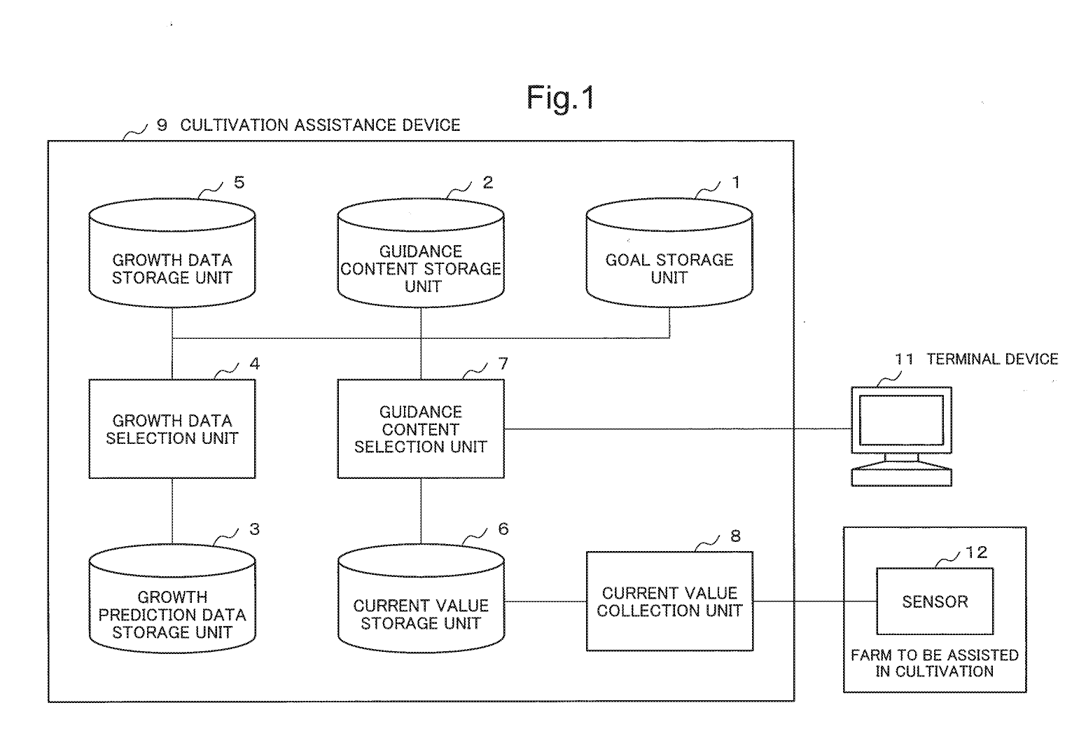

FIG. 1 is a block diagram illustrating an entire configuration of a cultivation assistance device 9 according to a first exemplary embodiment.

The cultivation assistance device 9 includes a goal storage unit 1, a guidance content storage unit 2, a growth prediction data storage unit 3, a growth data selection unit 4, a growth data storage unit 5, a current value storage unit 6, a guidance content selection unit 7, and a current value collection unit 8.

The guidance content selection unit 7 is connected with a terminal device 11. The current value collection unit 8 is connected with a sensor 12 which obtains data of a crop group to be cultivated with the assistance of the cultivation assistance device 9. The sensor 12 is located in, for example, the farm of a farmer who receives assistance service offered by the device.

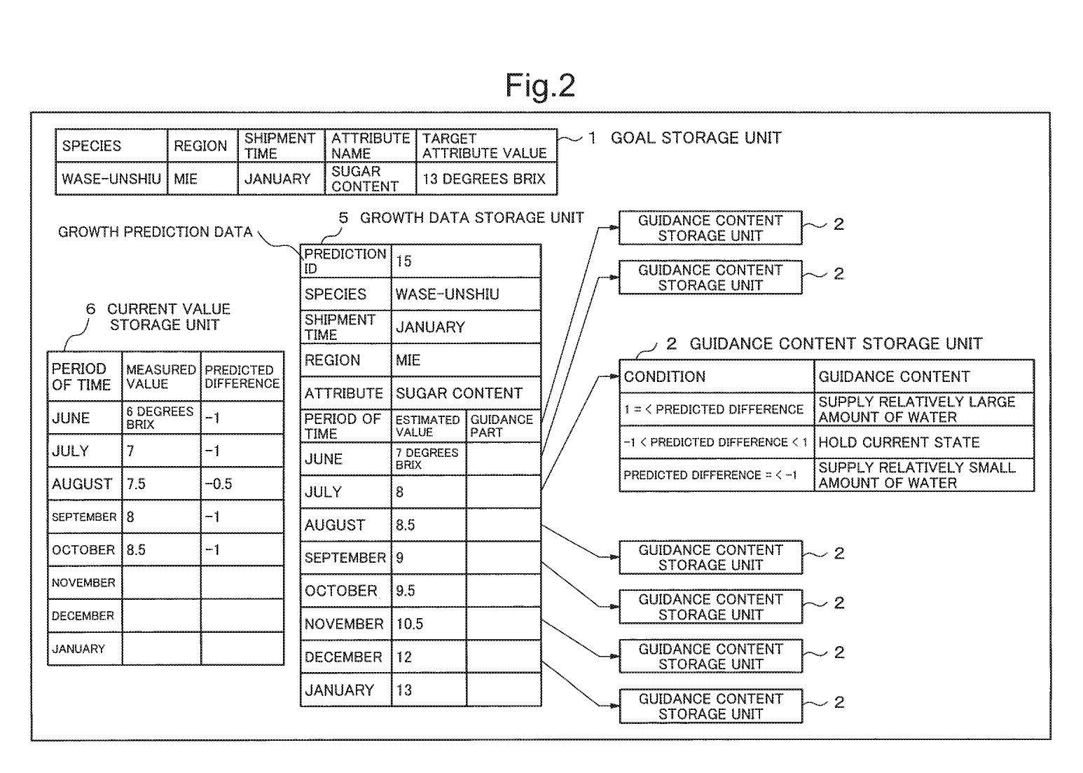

The goal storage unit 1, the guidance content storage unit 2, the growth data storage unit 5, and the current value storage unit 6 serve as storage devices which are implemented in, for example, magnetic disk devices or IC (Integrated Circuit) memory devices and respectively store data illustrated in, for example, FIG. 2.

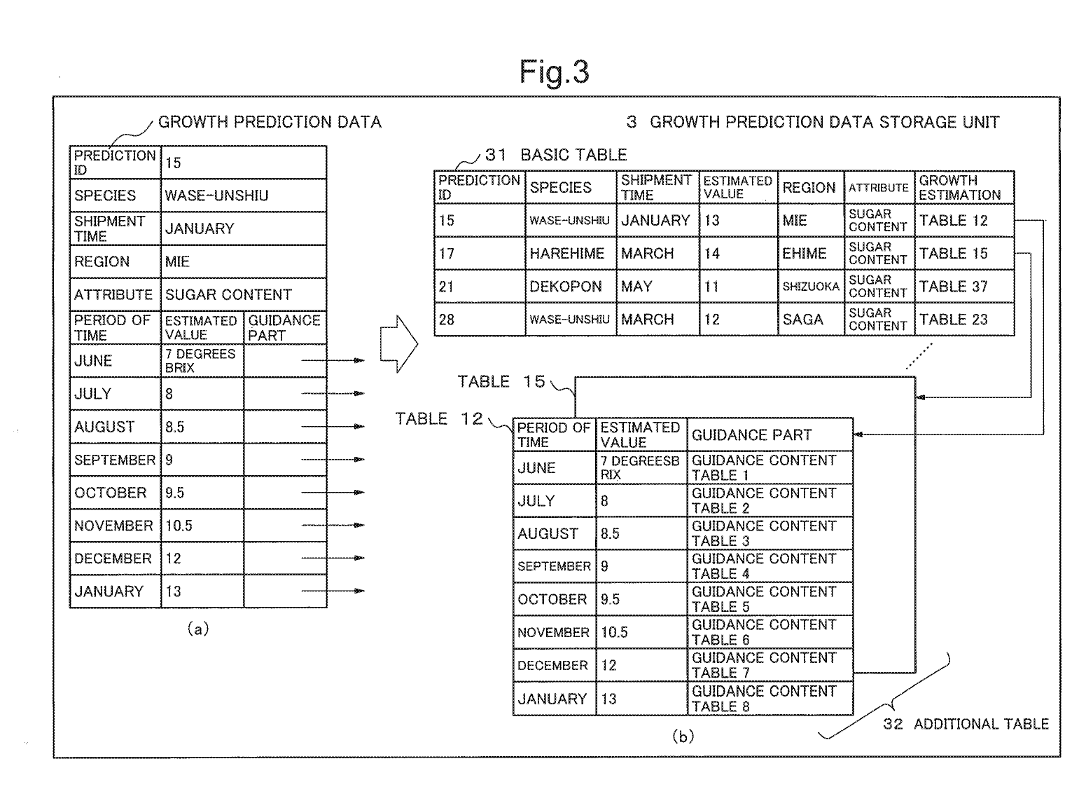

The growth prediction data storage unit 3 serves as a storage device which stores data illustrated in, for example, (b) of FIG. 3, that is, a plurality of growth prediction data having different cultivation regions, species, shipment times, target values (estimated values), or attributes.

The growth data selection unit 4 selects one growth prediction data from a plurality of growth prediction tables stored in the growth prediction data storage unit 3, based on the information stored in the goal storage unit 1, and stores the selected data in the growth data storage unit 5. More specifically, the growth data selection unit 4 selects, from the growth prediction data storage unit 3, growth prediction data having a cultivation region, species, shipment time, and attribute identical to those stored in the goal storage unit 1 and a target value equal to or close to that stored in the goal storage unit 1.

The current value collection unit 8 receives, from the sensor 12, data of a crop group to be cultivated with the assistance of the cultivation assistance device 9 and accumulates the received data in the current value storage unit 6. The accumulated data includes the measured values of the attributes stored in the goal storage unit 1. The current value collection unit 8 may receive data input by the farmer from, for example, a portable terminal device, instead of receiving measured values from the sensor 12.

The guidance content selection unit 7 compares the data accumulated in the current value storage unit 6 with the growth prediction data stored in the growth data storage unit 5, obtains a guidance content stored in the guidance content storage unit 2 in accordance with their difference between these two data, and displays this guidance content on, for example, the terminal device 11. The guidance content selection unit 7 may control, for example, an irrigation controller (not illustrated) in accordance with the guidance content.

The growth data selection unit 4, the guidance content selection unit 7, and the current value collection unit 8 are formed with electronic devices such as logic circuits. The growth data selection unit 4, the guidance content selection unit 7, or the current value collection unit 8 may be implemented with software executed by a processor (not illustrated) of the cultivation assistance device 9. In this case, the cultivation assistance device 9 is implemented in a computer.

FIGS. 2 and 3 are tables illustrating specific structures of data handled by the cultivation assistance device 9 according to the present exemplary embodiment.

The goal storage unit 1 stores a specific attribute of a shipped crop and its target attribute value, which are determined as an ideal situation for the shipped crop by the farmer, together with the species, the region, and the shipment time of the shipped crop. FIG. 2 illustrates an exemplary case where the farmer aims at shipping Wase-Unshiu with a sugar content of 13 degrees Brix in Mie in January. In this case, the species item is filled with “Wase-Unshiu,” the region item with “Mie,” the shipment time item with “January,” the attribute name item with “Sugar Content,” and the attribute value item with “13 Degrees Brix.”

The guidance content storage unit 2 stores a set of records including two items: the condition item and the guidance content item. The records stored in the guidance content storage unit 2 form an independent structure but are referred to by the respective guidance part items of the growth prediction data in the growth data storage unit 5. The records stored in the guidance content storage unit 2 are referred to only from the guidance part items of the growth prediction degrees Brix data in the growth data storage unit 5 and practically form part of the growth prediction degrees Brix data. Therefore, the guidance content storage unit 2 and the growth data storage unit 5 may be integrated together, although these two units are separated from each other in FIGS. 1 and 2.

When the data of the current value storage unit 6 satisfies a conditional expression in the condition item of the guidance content storage unit 2, the guidance content selection unit 7 presents the value of a corresponding guidance content item. Referring to FIG. 2, the condition items include (1=<Predicted Difference), (−1<Predicted Difference<1), and (Predicted Difference=<−1). The above-mentioned condition items respectively mean that (the value of the predicted difference is 1 or more), that (the value of the predicted difference is −1 (exclusive) to 1 (exclusive)), and that (the value of the predicted difference is −1 or less). The guidance content item paired with the condition item is data describing a guidance content which is output when the condition item is satisfied.

The growth prediction data storage unit 3 is a database storing a large number of growth prediction data. The growth prediction data includes a set of records including three items: the time item, the estimated value item, and the guidance part item, as well as items specifying the region, the species, the shipment time, and the attribute.

Records are created for each time point set at a predetermined interval from the beginning of cultivation until the harvest time for a product of a specific species which is cultivated in a specific region and shipped at a specific time, and the time item of each record specifies any of the plurality of set time points. The estimated value item stores an estimated attribute value (that is, an intermediate target value or a target value) in the process of cultivation or at the time of completion of cultivation in an average year at the time point specified in the time item for a specific attribute of a crop. The guidance part item stores condition-specific guidance contents or pointer information to the guidance content storage unit 2, for solving a discrepancy between the estimated attribute value and the actual measured value at each time if these values have the discrepancy.

FIG. 2 illustrates the structure of the growth prediction data in the form of data stored in the growth data storage unit 5. In this example, the data structure includes respective data items: the identifier (prediction ID), the species, the shipment time, and the region. In this example, the values of the respective data items are 15, Wase-Unshiu, January, Mie, and Sugar Content. This data structure continuously includes time-series records of three items: (Time, Estimated Value, Guidance Part). Note that in this example, the time is described on a month-by-month basis (June, July, . . . , January). The starting point is not limited to June. Further, the interval is not limited to one month. The interval may be on a day-by-day or week-by-week basis, or set randomly.

The growth prediction data storage unit 3 stores a large number of data structures similar to that illustrated herein. In one implementation example, this data structure is defined as one record for a database, and a database management system storing a large number of such records serves as the growth prediction data storage unit 3. Referring to FIG. 2, the growth prediction data is not represented in the table format of an RDB (Relational Database). This is because the data structure is represented compactly. FIG. 3 illustrates a more redundant data format when the growth prediction data is implemented in the table format of an RDB. The growth prediction data can be stored in an RDB by division into two tables: a basic table 31 and an additional table 32, as illustrated in FIG. 3.

In searching for growth prediction data matching the conditions, the growth data selection unit 4 uses an SQL search expression that is an RDB search expression. The basic table 31 illustrated in FIG. 3 stores four growth prediction data. The growth estimation items of individual growth prediction data include the IDs of the additional table 32. In, for example, the top growth prediction data, “Table 12” is stored as the value of the growth estimation item. Table 12 stores a plurality of records including three items: the time, the estimated value, and the guidance part.

The growth data selection unit 4 checks the growth prediction data in the growth prediction data storage unit 3 and selects and outputs one growth prediction data matching the species, region, shipment time, attribute, and target attribute value items in the goal storage unit 1. In practice, the growth data selection unit 4 performs selection after refinement using three items: the “species,” the “shipment time,” and the “region.” When the growth prediction data storage unit 3 is implemented in an RDBMS (Relational Database Management System), as illustrated in FIG. 3, the growth data selection unit 4 performs a search using SQL that is a search language for the RDBMS. For example, to find a record of growth prediction data matching a species (=Wase-Unshiu), a region (=Mie), a shipment time (=January), and a sugar content (=13 degrees Brix) stored in the goal storage unit 1 illustrated in FIG. 2, the growth data selection unit 4 may create the following SQL expression. The record having the prediction ID=15 is found out by an SQL expression defined as: SELECT*FROM Growth Prediction Data Table WHERE Shipment Time=January, Region=Mie, Species=Wase-Unshiu, Attribute=Sugar Content, Estimated Value=13.

The growth data storage unit 5 stores the growth prediction data selected by the growth data selection unit 4. When the growth prediction data storage unit 3 incorporates growth prediction data as illustrated in (a) of FIG. 3, the growth data storage unit 5 may hold only a prediction ID. For example, the guidance content selection unit 7 can extract the entire growth prediction data using an SQL expression defined as: SELECT*FROM Growth Prediction Data Table WHERE Prediction ID=15. FIG. 2 illustrates the case where the growth data storage unit 5 holds a replication of growth prediction data.

Note that a record of growth prediction data fully matching the conditions may be absent. For example, in the aforementioned example, a record of growth prediction data matching a species (=Wase-Unshiu), a region (=Mie), a shipment time (=January), and a sugar content (=13 degrees Brix) stored in the goal storage unit 1 may be absent. In other words, as a sugar content for a species (=Wase-Unshiu), a region (=Mie), and a shipment time (=January), a record indicating a sugar content of 12.8 degrees Brix may be present but a record indicating a sugar content of 13 degrees Brix may be absent. FIG. 7 illustrates an analog representation of the growth prediction data in an actual example. When the growth prediction data is changed from an analog representation that uses such a polygonal line graph into a table-format digital representation, growth prediction data fully matching the conditions may be absent. In this case, the use of a search expression defined as: “SELECT*FROM Growth Prediction Data Table WHERE Shipment Time=January, Region=Mie, Species=Wase-Unshiu, Attribute=Sugar Content, Estimated Value=13” is insufficient to allow the growth data selection unit 4 to find out a relevant record. As a coping method, the growth data selection unit 4 may be provided with a mechanism of searching for a similar record. Assume, for example, that the growth data selection unit 4 defines a search expression as: “Estimated Value between ((Value Obtained by Goal Storage Unit 1)−0.1×N, (Value Obtained by Goal Storage Unit 1)+0.1×N)”, instead of “Estimated Value=Value Obtained by Goal Storage Unit 1 (in the aforementioned example, 13),” where N is 0, 1, 2, . . . . The growth data selection unit 4 initially performs a search for N=0. The search condition in this case is defined as “Estimated Value=BETWEEN (Value Obtained by Goal Storage Unit 1, Value Obtained by Goal Storage Unit 1)” and is therefore equivalent to the original search expression. The BETWEEN clause is a standard SQL search representation. The general form of this search representation is “Search Item BETWEEN (Argument 1, Argument 2),” which means the search condition that the value of the search item is Argument 1 (inclusive) to Argument 2 (inclusive).

If no relevant record is found for N=0, the growth data selection unit 4 performs a search again for N=1. The search condition in this case is defined as “Estimated Value BETWEEN ((Value Obtained by Goal Storage Unit 1)−0.1, (Value Obtained by Goal Storage Unit 1)−0.1).” When this condition is applied to the aforementioned example, “Estimated Value BETWEEN (12.9, 13.1)” is obtained, which means the search condition that what should be searched for is an estimated value item having a value of 12.9 (inclusive) to 13.1 (inclusive). If no relevant record is found even by this operation, the growth data selection unit 4 performs a search again for N=2. The search condition in this case is defined as “Estimated Value BETWEEN (12.8, 13.2).” In this way, the growth data selection unit 4 gradually relaxes the search condition to find growth prediction data matching the goal of the goal storage unit 1.

A variety of methods are available to relax the search condition in the foregoing way and the method set forth herein is merely an example. The growth data selection unit 4 may relax the search condition using any method.

The current value storage unit 6 stores a table including a measured value item and a predicted difference item. The measured value item stores time-series data of specific attribute values at a specific time, which are periodically measured by the farmer in the process of cultivation. The predicted difference item stores the difference between the attribute value stored in the measured value item and the estimated value item at a corresponding time in the growth data storage unit 5. In the example illustrated in FIG. 2, the specific time is on a month-by-month basis (June, July, . . . , January). This means neither that the starting point is limited to June nor that the interval is limited to that on a month-by-month basis. The starting point may be another month, and the measurement interval may be on a day-by-day or week-by-week basis, or set randomly. The predicted difference item serves as a working area required in the course of processing and may not be provided to the current value storage unit 6.

The guidance content selection unit 7 is activated in response to, for example, periodical input of the measured values of a crop from the current value collection unit 8 by the farmer in the process of cultivation. The input measured values are stored in the current value storage unit 6. The guidance content selection unit 7 calculates the difference between the measured value item and the estimated value at a corresponding time in the growth data storage unit 5 and stores this difference in a corresponding predicted difference item. The guidance content selection unit 7 then extracts a guidance part item at the corresponding time in the growth data storage unit 5, extracts a guidance content for solving the obtained difference value, and outputs it to the terminal device 11. At this time, the guidance content selection unit 7 checks a conditional expression in the condition item of the guidance content storage unit 2 referred to from the guidance part item and finds a record having a condition item matching the value of the predicted difference item. The guidance content selection unit 7 outputs data described in the guidance content item of the found record, for example, a statement describing the guidance content.

The farmer may input the attribute, target value, species, region, and shipment time of a shipped crop from the terminal device 11 to the growth data selection unit 4. In this case, the growth data selection unit 4 obtains these values not from the goal storage unit 1 but from the terminal device 11.

The cultivation assistance device 9 according to the present exemplary embodiment makes it easy to achieve a target value, such as a target sugar content, at the time of shipment in the cultivation of farm products. This is because the growth data selection unit 4 selects, from the growth prediction data storage unit 3, growth prediction data matching a given target condition and stores this data in the growth data storage unit 5. The guidance content selection unit 7 then determines and outputs a guidance content, based on the growth prediction data.

### Second Exemplary Embodiment

The present exemplary embodiment is a modification to the first exemplary embodiment. In the present exemplary embodiment, the farmer sets target values for a plurality of attributes of a shipped crop, such as hardness as well as the sugar content, and stores these target values in a goal storage unit 1.

The growth data selection unit 4 selects growth prediction data for each of the plurality of attributes and stores all of them in a growth data storage unit 5. The current value collection unit 8 accumulates a measured value for each of the plurality of attributes in the current value storage unit 6, for a crop to be cultivated with assistance. The guidance content selection unit 8 outputs a guidance content corresponding to each of the plurality of attributes.

Other features of a cultivation assistance device 9 according to the present exemplary embodiment are the same as in the first exemplary embodiment.

The cultivation assistance device 9 according to the present exemplary embodiment makes it easy to achieve a plurality of target values, such as a target sugar content and a target hardness, at the time of shipment in the cultivation of farm products. This is because the growth data selection unit 4 selects, from a growth prediction data storage unit 3, a plurality of growth prediction data matching a target condition including target values for a plurality of given attributes and stores the selected data in the growth data storage unit 5. A guidance content selection unit 7 then determines and outputs a guidance content, based on the plurality of growth prediction data.

### Third Exemplary Embodiment

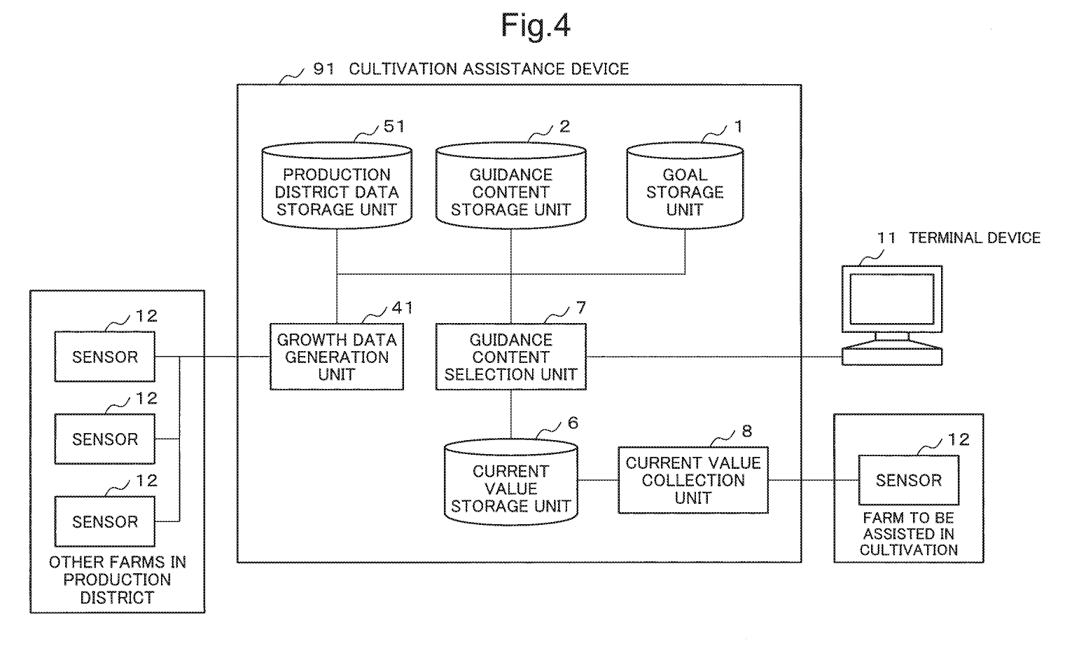

FIG. 4 illustrates an entire configuration of a cultivation assistance device 91 according to a third exemplary embodiment. The cultivation assistance device 91 according to the present exemplary embodiment includes a production district data storage unit 51 and a growth data generation unit 41, in place of the growth data selection unit 4 and the growth data storage unit 5. The cultivation assistance device 91 according to the present exemplary embodiment does not include the growth prediction data storage unit 3.

The growth data generation unit 41 is connected to sensors 12 that obtain data of a group of crops for which a production district, a species, and a shipment time are specified by data in the goal storage unit 1 and which are other than crops to be cultivated with the assistance of the cultivation assistance device 91. The growth data generation unit 41 collects, from the sensors 12, the measured values of attributes specified by the data in the goal storage unit 1 and generates production district growth data in the production district data storage unit 51. The growth data generation unit 41 may receive, for example, data input from a portable terminal device by a farmer, instead of receiving measured values input from the sensor 12.

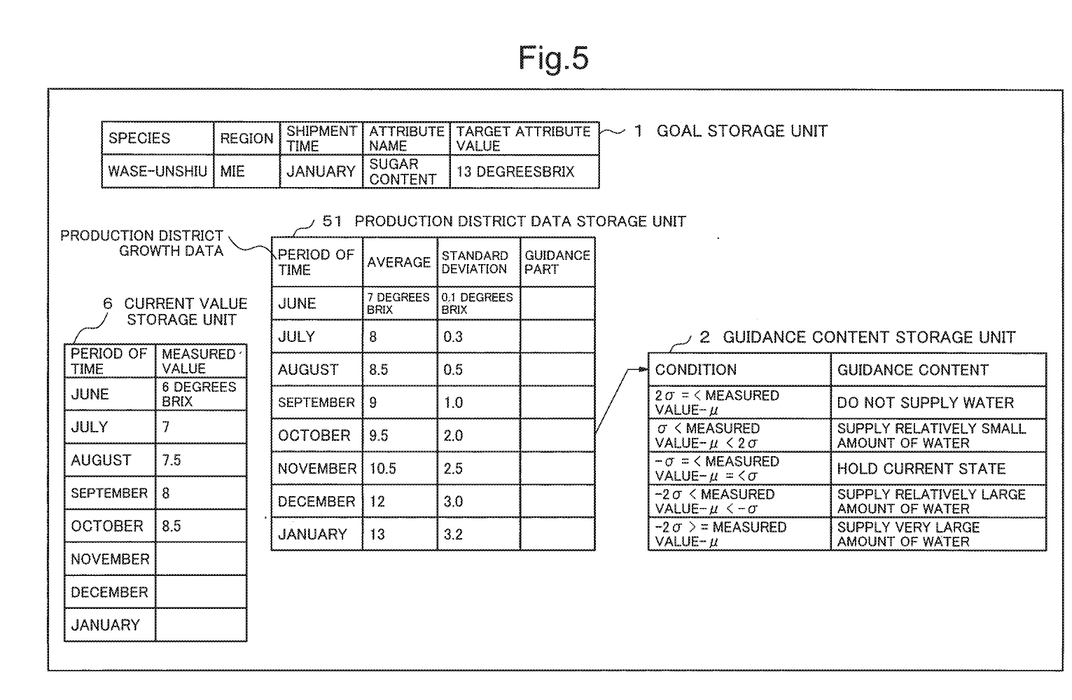

The production district data storage unit 51 serves as a storage device which is implemented with, for example, a magnetic disk device or an IC memory device and stores production district growth data illustrated in, for example, FIG. 5. The growth data generation unit 41 is formed with an electronic device such as a logic circuit. The growth data generation unit 41 may be implemented with software executed by a processor (not illustrated) of the cultivation assistance device 91. In this case, the cultivation assistance device 91 is implemented with a computer.

The production district data storage unit 51 stores production district growth data. The production district growth data includes a set of records including four items: the time item, the average item, the standard deviation item, and the guidance part item. The production district growth data may include items specifying the region, the species, the shipment time, and the attribute. Records included in the production district growth data are created for each time point set at a predetermined interval from the beginning of cultivation until the harvest time, and the time item of each record specifies any of the plurality of set time points. The average item and the standard deviation item are stored as time-series data of the average and the standard deviation of periodically measured values of an attribute value of a specific attribute for a crop under cultivation by a plurality of other farmers in a production district to which the farmer assisted by the cultivation assistance device 91 belongs. The guidance part item stores condition-specific guidance contents for solving a discrepancy at each time or pointer information to the guidance content storage unit 2, for conditions for a discrepancy of specific actual measured attribute values in comparison with the average item and standard deviation item.

FIG. 5 illustrates an example for the sugar content. The production district growth data includes monthly data of average and standard deviation. These values can be calculated from values measured by a device (for example, a saccharimeter) placed in an agricultural cooperative by an agricultural management instructor, targeting at, for example, fruits that are under cultivation and periodically brought by farmers. For example, a personal computer placed in the agricultural cooperative may accumulate the measured values, calculate an average and a standard deviation, and send them to the cultivation assistance device 91. Alternatively, the growth data generation unit 41 may calculate an average and a standard deviation based on measured values collected from the sensors 12. The production district growth data may not necessarily store the standard deviation.

The guidance content storage unit 2 may be the same as in the first exemplary embodiment when the production district growth data stores only the average and does not store the standard deviation. When the production district growth data includes the average and the standard deviation, the condition item of the guidance content storage unit 2 is divided into 2σ=<Measured Value−μ, σ<Measured Value−μ<2σ, −σ=<Measured Value−μ=<σ, −2σ<Measured Value−μ<−σ, and −2σ>=Measured Value−μ, as illustrated in FIG. 5, where σ is the standard deviation, μ is the average, and Measured Value denotes the value of the measured value item of a current value storage unit 6. In this example, the dividing condition is defined as information indicating whether the value of the measured value item of the current value storage unit 6 falls within the range (σ) of standard deviation in the production district, falls within the range of 2σ, or falls outside the range of 2σ.

As illustrated in FIG. 9, when the measured value conforms to a normal distribution, the discrepancies of individual measured values from the average fall within σ at 68%, 2σ at 95%, and 3σ at 99.7%. In the above-mentioned condition, a crop cultivated with assistance is classified into a group in which the crop is average (within σ), deviates slightly (within 2σ), or is almost exceptional (outside 2σ) in the production district. The guidance content of the guidance content storage unit 2 incorporates, on the basis of the classification, advice as to whether the current cultivation state should be changed. The guidance content item is assumed to be described by a cultivation expert.

The guidance content selection unit 7 is activated in response to input of the measured value item of the current value storage unit 6 by the farmer to find a record having a time item corresponding to the specific time in the production district data storage unit 51. The guidance content selection unit 7 checks the condition item of the guidance content storage unit 2 referred to by the guidance part item of the record, and extracts and outputs the value of a guidance content item matching the condition of a discrepancy between the measured attribute values and the values of the average and standard deviation items in the record.

The dividing conditions are set to the ranges of σ and 2 σ in the example illustrated in FIG. 5 but are not limited to this.

Parts other than the above description in the present exemplary embodiment are the same as in the first exemplary embodiment.

The cultivation assistance device 91 according to the present exemplary embodiment makes it easy to achieve a target value, such as a target sugar content, at the time of shipment in the cultivation of farm products. This is because the growth data generation unit 4 generates production district growth data matching a given target condition from the measured values of a crop in a specific production district and stores this data in a growth data storage unit 5. The guidance content selection unit 7 then determines and outputs a guidance content, on the basis of the production district growth data.

### Fourth Exemplary Embodiment

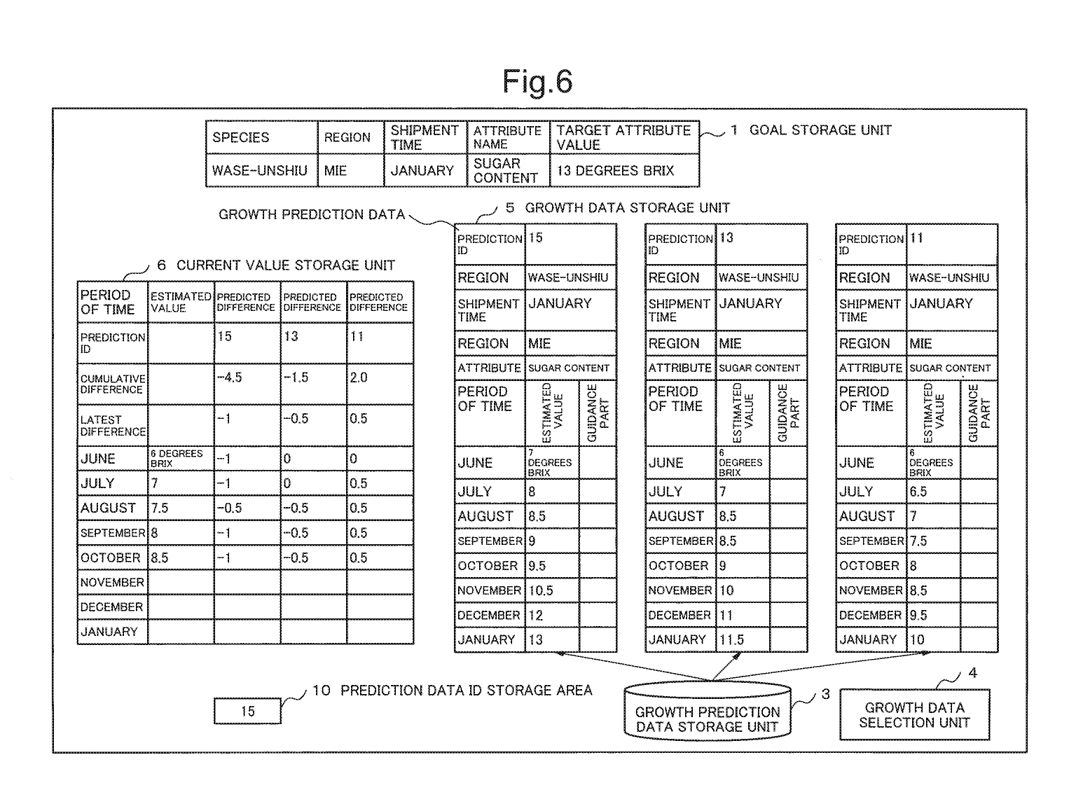

The present exemplary embodiment is a modification to the first exemplary embodiment. FIG. 6 illustrates data stored in a cultivation assistance device 9 according to the present exemplary embodiment.

In the present exemplary embodiment, the growth data selection unit 4 checks growth prediction data in the growth prediction data storage unit 3, selects a plurality of growth prediction data matching the species, region, shipment time, attribute, and target attribute value items in the goal storage unit 1 in descending order of degree of matching, and stores the selected data in the growth data storage unit 5. The difference from the growth prediction data selection unit 4 according to the first exemplary embodiment lies in that a plurality of predicted degrees Brix data are output for a specified attribute. As described in the first exemplary embodiment, the growth prediction data selection unit 4 searches for growth prediction data satisfying the condition of the goal storage unit 1 but gradually relaxes the search condition when no relevant data is found. The growth data selection unit 4 searches for a plurality of growth prediction data while gradually relaxing the search condition in selecting a plurality of predicted degrees Brix data. The number of growth prediction data to be selected is provided to the cultivation assistance device 9 as a parameter. This number is generally more than two but may be larger than the former. FIG. 6 illustrates the selection of three candidates as an example.

The cultivation assistance device 9 stores the ID of best-matched growth prediction data at the current moment in a prediction data ID storage area 10 within its memory, among a plurality of growth prediction data selected by the growth data selection unit 4. The best-matched predicted degrees Brix data is a record found with a minimum degree of relaxation in the process of gradually relaxing the condition by the growth data selection unit 4.

The current value storage unit 6 stores a set of records including the measured value items described in the first exemplary embodiment. The record stored in the current value storage unit 6 further includes a plurality of predicted difference items serving as the differences between the attribute values stored in the above-mentioned measured value items and the estimated value items at a corresponding time in the above-mentioned plurality of growth prediction data. In the example illustrated in FIG. 6, since the growth prediction data storage unit 3 stores three growth prediction data, three predicted difference items are present as well. This number is not limited to three. The predicted difference item serves as a working area required in the course of processing and may not be provided to the current value storage unit 6. The current value storage unit 6 according to the present exemplary embodiment also stores a record (cumulative value record) including a cumulative difference item which stores cumulative values from the difference at the start of measurement to the latest difference, for each growth prediction data, as well as the above-mentioned set of records.

The guidance content selection unit 7 is activated in response to, for example, periodical input of the measured values of a crop from the current value collection unit 8 by the farmer in the process of cultivation. The input measured values are stored in the current value storage unit 6. The guidance content selection unit 7 calculates the difference between such a measured value item and the estimated value at a corresponding time of each of the plurality of growth prediction data stored in the growth data storage unit 5 and stores this difference in a corresponding predicted difference item. The guidance content selection unit 7 associates the difference calculated for each of the plurality of growth prediction data with a corresponding one of the plurality of growth prediction data and accumulates the associated data in a cumulative value record. The guidance content selection unit 7 then extracts growth prediction data having an ID held in the prediction data ID storage area 10 from the growth data storage unit 5.

The guidance content selection unit 7 further extracts a guidance part item at the corresponding time in the growth data storage unit 5, extracts a guidance content for solving the obtained difference value, and outputs it to a terminal device 11. This processing is the same as in the first exemplary embodiment. Therefore, FIG. 6 does not illustrate parts subsequent to the guidance part item.

The guidance content selection unit 4 further refers to a plurality of cumulative difference item values in the cumulative value record of the current value storage unit 6 to check whether the growth prediction data specified by the prediction data ID storage area 10 is best-matched to the measured value, that is, the cumulative difference item value is minimal. If the growth prediction data specified by the prediction data ID storage area 10 is best-matched to the measured value, the process ends with no particular actions; otherwise, the ID of best-matched growth prediction data is output to the terminal device 11.

Details will be described with reference to the example illustrated in FIG. 6. Referring to FIG. 6, three growth prediction data are stored in the growth data storage unit 5. These data have 15, 13, and 11 as prediction IDs. Predicted degrees Brix data having a prediction ID=15 is growth prediction data showing a sugar content of 13 degrees Brix in January. Thus, predicted degrees Brix data having a prediction ID=15 is selected as a best-matched one at the beginning and a prediction ID=15 is stored in the prediction data ID storage area 10. Growth prediction data having a prediction ID=13 shows a sugar content of 11.5 degrees Brix in January and growth prediction data having a prediction ID=11 shows a sugar content of 10 degrees Brix in January; growth prediction data having prediction IDs=13 and 11 show sugar contents at the time of shipment (=January) lower than that shown in the data having a prediction ID=15. Since the farmer has set the target sugar content at the time of shipment to 13 degrees Brix, predicted degrees Brix data having a prediction ID=15 is selected. However, with growth over June and July, the current value is becoming discrepant from growth prediction aiming at a sugar content of 13 degrees Brix. In October, the cumulative difference between the current value and growth prediction aiming at 13 degrees Brix has reached −4.5. The cumulative difference between the current value and growth prediction data having a prediction ID=13 is −1.5 and the cumulative difference between the current value and growth prediction data having a prediction ID=11 is +2.0. Even if the target at the time of shipment in January is changed to a sugar content of 11.5 degrees Brix, a delay of growth has already occurred in terms of sugar content in October. If the target is changed to a sugar content of 10 degrees Brix, the current rate of growth is naturally higher than the rate of growth specified by this target. The instructor of the agricultural cooperative may advise as follows: “Although your target is a sugar content of 13 degrees Brix, a delay of growth has currently occurred in comparison with growth prediction aiming at 13 degrees Brix and the sugar content is in a range between 11.5 degrees Brix and 10 degrees Brix. Lower the target from 13 degrees Brix to 11.5 degrees Brix.” If there still remains any means for rapidly increasing the sugar content in October, the instructor of the agricultural cooperative may send an encouragement as follows: “Do your best to increase the sugar content by more severely restricted water supply.”

The cultivation assistance device 9 according to the present exemplary embodiment advises as follows: “Your current crop state is closer to a target lower by one level than your current target value. Would you like to change your target?” More specifically, when the farmer inputs a new measured value, three cumulative difference items of the current value storage unit 6 and three latest difference values are presented to the farmer in sequence for discrepancies between growth prediction data having prediction IDs=15, 13, 11 and the target of the farmer.

The cultivation assistance device 9 according to the present exemplary embodiment enables setting of an appropriate cultivation target value. This is because the growth data selection unit 4 stores a plurality of growth prediction data in the growth data storage unit 5 for a specified attribute. After that, the guidance content selection unit 7 outputs an identifier for growth prediction data having a small difference between the measured value and the intermediate target value.

### Fifth Exemplary Embodiment

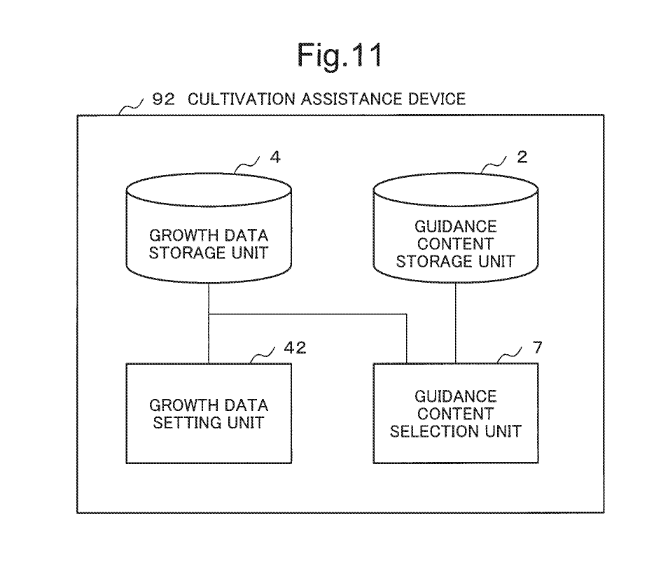

FIG. 11 illustrates an entire configuration of a cultivation assistance device 92 according to the present exemplary embodiment.

The cultivation assistance device 92 according to the present exemplary embodiment includes a growth data setting unit 42, the growth data storage unit 4, the guidance content storage unit 2, and the guidance content selection unit 7. The growth data setting unit 42 selects or generates a growth table including intermediate target values, which are determined from cultivation conditions including the cultivation region, the species, the shipment time, and the final target value, for a plurality of intermediate time points until the shipment time and stores this table in a growth data storage means. The guidance content storage unit 2 stores a guidance content depending on a difference between the measured value and the intermediate target value for a crop to be cultivated with assistance. The guidance content selection unit 7 obtains a measured value for a crop to be cultivated with assistance at each of a plurality of intermediate time points, compares the obtained measured value with the intermediate target value at this intermediate time point, and selects and outputs a guidance content from a guidance content storage means based on the difference between these two values.

The cultivation assistance device 92 according to the present exemplary embodiment makes it easy to achieve a target value, such as a target sugar content, at the time of shipment in the cultivation of farm products. This is because the growth data setting unit 42 selects or generates growth prediction data matching a given target condition and stores this data in the growth data storage unit 4. The guidance content selection unit 7 then determines and outputs a guidance content, on the basis of the growth prediction data.

The present invention has been described above with reference to exemplary embodiments but is not limited to the above-described exemplary embodiments. Various changes which would be understood by those skilled in the art can be made to the arrangements and details of the present invention without departing from the scope of the present invention.

This application claims priority based on Japanese Patent Application No. 2013-182958 filed on Sep. 4, 2013, the disclosure of which is incorporated herein by reference in its entirety.

### REFERENCE SIGNS LIST

1: goal storage unit
2: guidance content storage unit
3: growth prediction data storage unit
4: growth data selection unit
5: growth data storage unit
6: current value storage unit
7: guidance content selection unit
8: current value collection unit
9, 91, 92: cultivation assistance device
10: prediction data ID storage area
11: terminal device
12: sensor
41: growth data generation unit
42: growth data setting unit
51: production district data storage unit

What is claimed is:

1. A cultivation assistance device comprising:
circuitry configured to:
select or generate a growth table including intermediate target values for a plurality of intermediate time points until the shipment time, and store the growth table, the intermediate target values being determined from cultivation condition including a cultivation region, a species, a shipment time, and a final target value;
store a guidance content depending on differences between the intermediate target values and measured value for a crop to be cultivated with assistance; and
acquire the measured value for the crop to be cultivated with assistance at an intermediate time point in the plurality of intermediate time points, for each of the plurality of intermediate time points, compare the measured value with an intermediate target value at the intermediate time point in the intermediate target values, and select and output the guidance content, based on differences between the measured value and the intermediate target value.

2. The cultivation assistance device according to claim 1,
wherein the circuitry is further configured to:
store the growth table associated with the cultivation condition for each of a plurality of cultivation conditions, the growth table including the intermediate target values for the plurality of intermediate time points, and
acquire the cultivation condition for the crop to be cultivated with assistance, and select, the growth table associated with the cultivation condition that are identical in cultivation region, species, and shipment time to the acquired cultivation condition and equal or close in final target value to the acquired cultivation condition.

3. The cultivation assistance device according to claim 2, wherein
the circuitry is further configured to:
select and store a plurality of growth tables, and
acquire the measured value for the crop to be cultivated with assistance, compare the measured value with the intermediate target value in each of the plurality of growth tables, and output identification information for the growth table having a minimum difference.

4. The cultivation assistance device according to claim 1, wherein
the circuitry is further configured to:
generate the growth table by acquiring the measured value measured for each of a plurality of crop groups for each time period generated by dividing at each of the plurality of intermediate time points, calculating a statistical value for the measured value, and storing the statistical value in association with one of the plurality of intermediate time points, the plurality of crop groups being other than the crop to be cultivated with assistance and having an identical cultivation condition.

5. The cultivation assistance device according to claim 1, wherein
the circuitry is further configured to:
store a growth table including the intermediate target values for each of a plurality of attributes,
store the guidance content depending on a difference between the intermediate target values and the measured value for each of the plurality of attributes with regard to the crop to be cultivated with assistance, and
acquire, at each of the plurality of intermediate time points, the measured value for the crop to be cultivated with assistance for each of the plurality of attributes, compare the measured value with the intermediate target values, and select and output the guidance content, based on differences between the measured value and the intermediate target values.

6. A cultivation assistance method comprising:
selecting or generating a growth table including intermediate target values for a plurality of intermediate time points until the shipment time, and storing the growth table in growth data storage, the intermidiate target values being determined from cultivation condition including a cultivation region, a species, a shipment time, and a final target value;
storing, in guidance content storage, a guidance content depending on differences between the intermediate target values and measured values for a crop to be cultivated with assistance; and
acquiring the measured value for the crop to be cultivated with assistance at an intermediate time point in the plurality of intermediate time points, for each of the plurality of intermediate time points, comparing the measured value with an intermediate target value at the intermediate time point in the intermediate target values, and selecting and outputting the guidance content from the guidance content storage, based on differences between the measured values and the intermediate target value.

7. The cultivation assistance method according to claim 6, further comprising:
storing the growth table associated with the cultivation condition for each of a plurality of cultivation conditions in growth prediction data storage, the growth table including the intermediate target values for the plurality of intermediate time points; and
acquiring the cultivation condition for the crop to be cultivated with assistance, and selecting, from the growth prediction data storage, the growth table associated with the cultivation condition that are identical in cultivation region, species, and shipment time to the acquired cultivation condition and equal or close in final target value to the acquired cultivation condition.

8. A non-transitory computer readable recording medium storing a program causing a computer to execute:
processing of selecting or generating a growth table including intermediate target values for a plurality of intermediate time points until the shipment time, and storing the growth table in growth data storage, the intermidiate target values being determined from cultivation condition including a cultivation region, a species, a shipment time, and a final target value;
processing of storing, in guidance content storage, a guidance content depending on differences between the intermediate target values and measured values for a crop to be cultivated with assistance; and
processing of acquiring the measured value for the crop to be cultivated with assistance at an intermediate time point in the plurality of intermediate time points, for each of the plurality of intermediate time points, comparing the measured values with an intermediate target value at the intermediate time point in the intermediate target values, and selecting and outputting the guidance content from the guidance content storage, based on differences between the measured value and the intermediate target value.

9. The non-transitory computer readable recording medium according to claim 8, storing the program the program further causing a computer to execute:
processing of storing the growth table associated with the cultivation condition for each of a plurality of cultivation conditions in growth prediction data storage, the growth table including the intermediate target values for the plurality of intermediate time points; and
processing of acquiring the cultivation condition for the crop to be cultivated with assistance, and selecting, from the growth prediction data storage, the growth table associated with the cultivation condition that are identical in cultivation region, species, and shipment time to the acquired cultivation condition and equal or close in final target value to the acquired cultivation condition.
